(19) United States
(12) Patent Application Publication
(10) Pub. No.: US 2010/0293067 A1
(43) Pub. Date: Nov. 18, 2010

(54) Real Estate Closing Card

(76) Inventor: Jeffrey A. Gacek, White Bear Lake, MN (US)

Correspondence Address: William Mitchell College of Law Intellectual;Property Law Clinic, 875 Summit Avenue, St. Paul, MN, 55105, US

(21) Appl. No.: 12/781,234

(22) Filed: May 17, 2010

Related U.S. Application Data
(60) Provisional application No. 61/179,169, filed on May 18, 2009.

(51) Int. Cl. G06Q 30/00; B32B 37/14

(52) U.S. Cl. 705/26; 40/124.01; 40/124.09; 229/92.8; 493/405; 234/1; 156/300

(57) ABSTRACT

A multi-use real estate closing card is described. A real estate closing card may be used as an advertising tool, a closing gift from real estate vendors to new home owners, and a moving announcement for the homeowner. The real estate closing card has at least two information blocks that can comprise an announcement block and an advertising block. Information may be text or visual representation, such as photographs or drawings of the home or family.

### RELATED APPLICATIONS

This application claims the benefit of U.S. Provisional Patent Application No. 61/179,169, filed May 18, 2009, the disclosures of which are hereby incorporated by reference herein in their entirety except for definitions defined therein.

### FIELD OF THE INVENTION

The invention described is directed to a multi-use closing card. More particularly, the invention is directed to a card, suitable for use in the real estate market as a closing gift, moving announcement and business marketing device.

### BACKGROUND OF THE INVENTION

Buying a home is an important event in one's life. Buyers work closely with their real estate company and/or agent and closing company (real estate vendors) to find the perfect home. A tradition in the real estate industry is for vendors to celebrate this milestone, and show their appreciation to the client for choosing them to provide their services, by giving a gift to the buyer at closing. The gifts are often of low value, are branded and have a real estate motif.

Real estate vendors need to market their services and one of the best ways to do this is to show that they are able to find the perfect home for their clients. In addition, home buyers often wish to send announcements to family, friends, colleagues, coworkers and vendors, letting them know that they have purchased a new home. There is a need for a product that combines these features, offering an affordable, multi-use gift for the new home buyer.

### BRIEF SUMMARY OF THE INVENTION

The present disclosure describes a closing card, a product that may be used for a closing gift, a moving announcement, and a business marketing tool. The closing card allows the real estate vendor to provide a gift of moving announcements that the buyer can send to family and friends, which also acts as an advertising or marketing device for the vendor. As will become apparent upon reading the Detailed Description below, the present invention provides a solution to the needs identified above and offers other advantages over the prior art.

One embodiment of a closing card device offers a multi-use product that can be used as a closing gift from the real estate vendor to the home buyer. The closing card comprises a paper product (coated or uncoated, virgin paper or recycled) or a plastic product, with at least two blocks of information and/or graphics, for a visual presentation that conveys a moving announcement for a home buyer and a marketing tool for real estate vendors. In another embodiment, the closing card comprises a laminated paper material with at least two blocks of information and/or graphics for a visual presentation that conveys a moving announcement for a home buyer and a marketing tool for real estate vendors. In yet another embodiment, the closing card comprises a thin plastic material with at least two blocks of information and/or graphics for a visual presentation that conveys a moving announcement for a home buyer and a marketing tool for real estate vendors.

The closing card can also take on a number of other embodiments, several of which are described below. In general, the card comprises at least a first side, and optionally, a second side of a flat surface bearing visual representations of at least one announcement block and one advertising block. Variations include closing cards of various sizes with or without a fold and cards with a perforated business card attachment that may be removed and kept for future reference or passed along to friends.

Additional advantages and features of the invention will be set forth in part in the description which follows, and in part, will become apparent to those skilled in the art upon examination of the following or may be learned by practice of the invention.

### BRIEF DESCRIPTION OF THE DRAWINGS

These as well as other objects and advantages of this invention will be more completely understood and appreciated by referring to the following more detailed description of the exemplary embodiments of the invention in conjunction with the accompanying drawings of which:

FIG. 1 illustrates examples of a business card-size closing card

FIG. 2 illustrates a double business card-size, foldable closing card

FIG. 3 show the closing card features on a sticky note

FIG. 4 presents an example of a post card-size closing card

FIG. 5 depicts examples of vertical closing cards

FIG. 6 illustrates a variation on the vertical closing card with a perforated business card

FIG. 7 illustrates a note card embodiment of a closing card

While the invention is amenable to various modifications and alternative forms, specifics thereof have been shown by way of example in the drawings and will be described in detail. It should be understood, however, that the intention is not to limit the invention to the particular embodiments described. On the contrary, the invention is to cover all modifications, equivalents, and alternatives.

### DETAILED DESCRIPTION

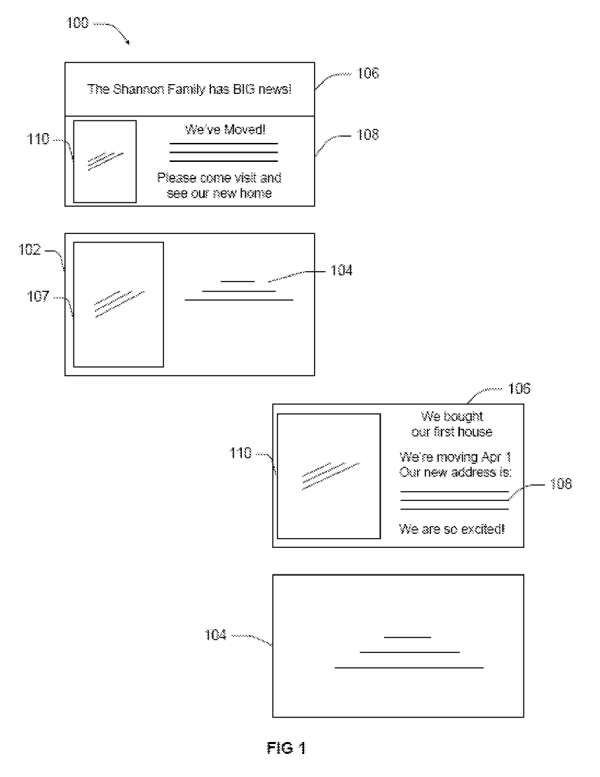

FIG. 1 illustrates a business card-sized embodiment 100 of the closing card. Two examples are provided. Each card has a first side and a second side onto which the features of the invention may be placed. Particularly, an advertising block 102 providing vendor advertising or contact information 104 may be placed on one area of the card. Additional marketing information, and a photograph of the agent 107 or business logo may also be provided. An announcement block 106 may be placed on another area. The announcement block 106 may include a greeting or invitation, the new home address 108 and, in a preferred embodiment, a visual representation of the buyer's new home and/or the family 110. Either block may be as elaborate so as to fill an entire side of a card, or may be as spare so as to contain only a few details.

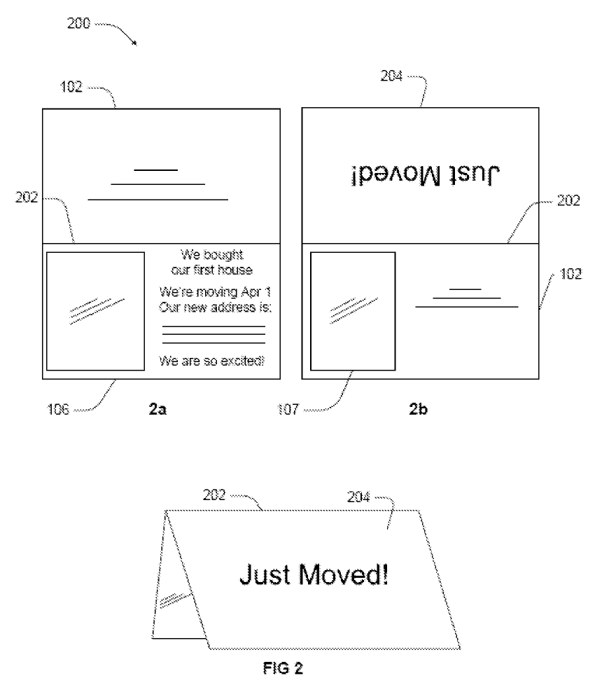

FIG. 2 illustrates a double business card-size closing card that may be folded in half along a mid-width fold 202. This type of configuration features additional surfaces on which announcements or advertising may be placed. Particularly, an exemplary closing card can have the advertising block 102 and the announcement block 106 on both the inside (2a) and on the outside (2b) surfaces.

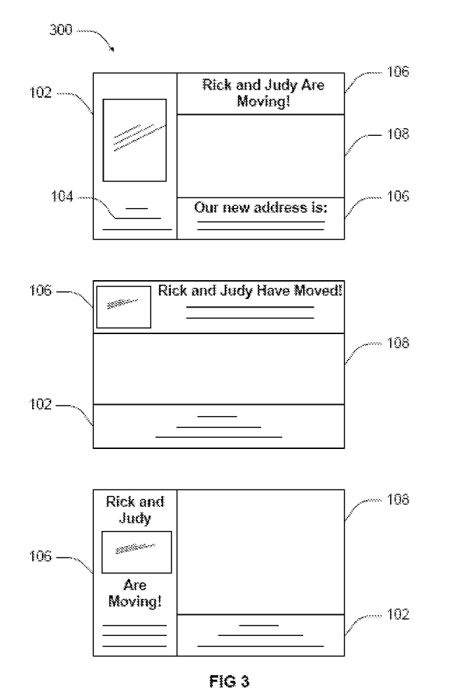

The invention also lends itself well to note paper or sticky notes. FIG. 3 illustrates examples 300 of the closing card on a sticky note. As shown, each note contains at least one advertising block 102, which may include a visual representation of the vendor as well as contact information 104 and at least one announcement block 106. Space is available to include visual representations of the home, the family, or the vendor may also be provided, and open space is provided for writing notes 108.

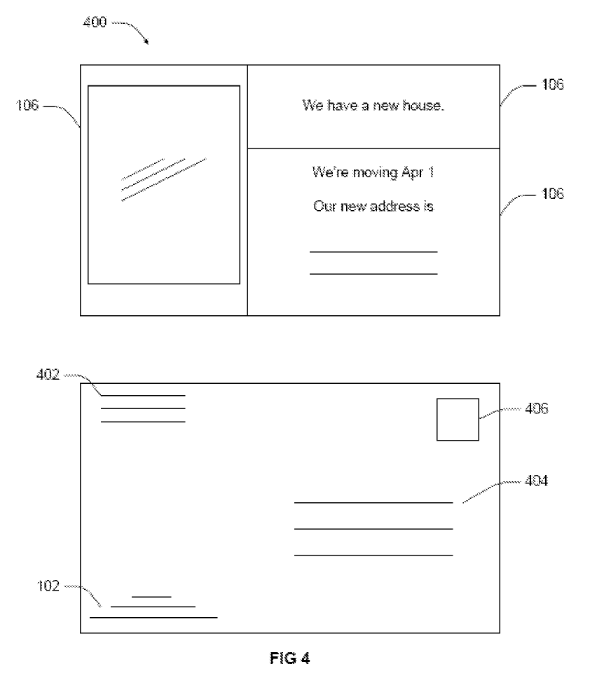

FIG. 4 illustrates a flat, two-sided post card featuring the advertising block 102 and announcement block 106. As shown in FIG. 4, the announcement block 106 can contain a short message such as a greeting, an invitation to visit, and/or the date of the move. In one embodiment, the announcement block can display one or more pictures of the home and family. One side of the closing card is formatted for mailing with a return address 402 and space for the recipient's address 404 and postage 406.

Referring again to FIG. 4, the advertising block 102 for a closing card can provide just a short message noting the vendor and the vendor's basic contact information. FIG. 4 further illustrates the card with more extensive announcement information, including a picture of the home or family, the announcement, moving date and new address.

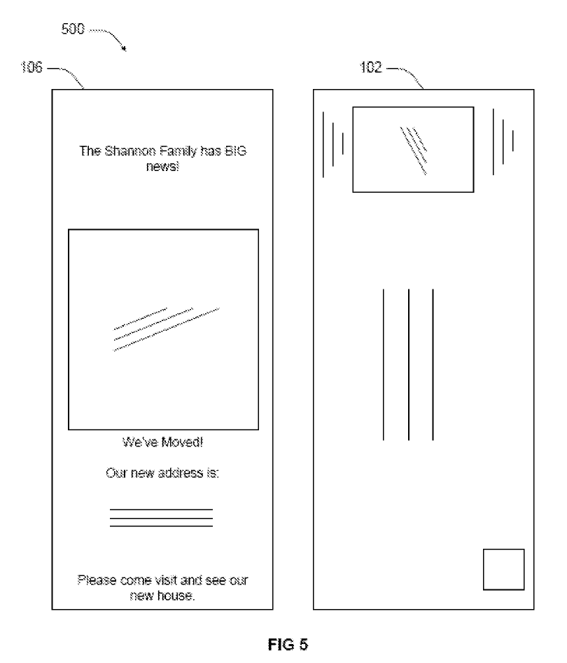

FIG. 5 illustrates a mailable, vertical post-card formatted similar to the post cards in FIG. 3, however, these examples may be either mailed as post cards or sent in a regular number 10 business size envelope. As shown in FIG. 5, one side is comprised of an announcement block with photograph, announcement, moving date and invitation. Alternatively, space may be provided on the announcement side 106 for a handwritten invitation. An advertising block 102 is provided on the address side of the card, along with space for return address, address and postage.

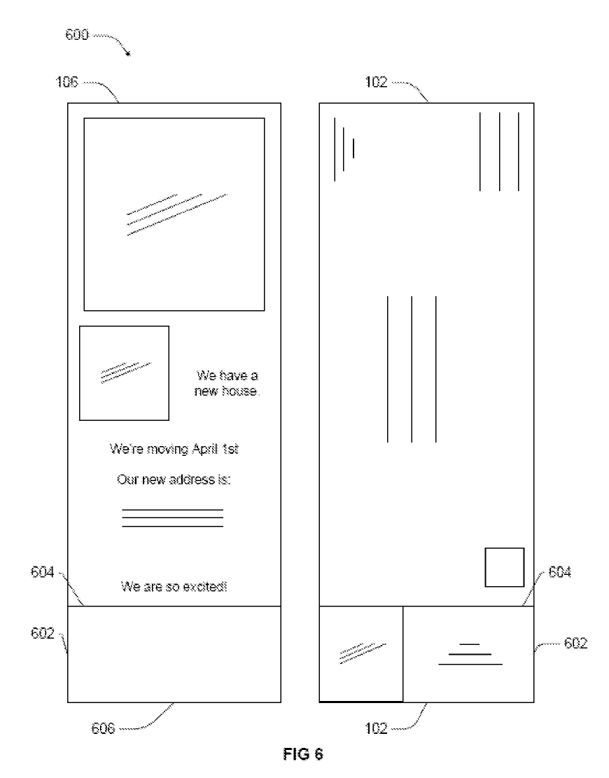

A variation on the vertical post-card embodiment is shown in FIG. 6. One side of the card is comprised of the announcement block 106. The other side of the card provides the address, return address and postage space. In addition, the advertising block 102 is presented as a business card 602 attached to a short end of the card; the point of attachment may be perforated 604 for easy folding and removal for use as a convenient referral object. One side of the perforated business card 606 may be blank for writing personal messages.

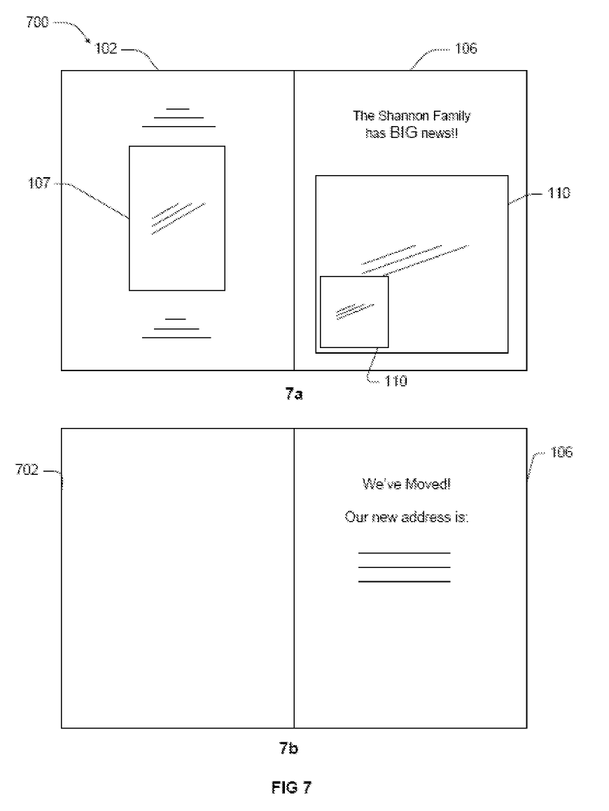

FIG. 7 shows two sides of an embodiment of closing note cards. In the examples shown, one side, functioning as an outside cover and back 7a of a card when folded, can have both an advertising block 102 and an announcement block 106. The example depicted includes pictures of the family and home 110 on the front cover, and a picture of the vendor 107 on the back cover. The inside 7b of the card can have an announcement block 106 with greeting or invitation and open space 702 allowing the sender to include a personal message for the recipient.

Although there are several sample preferred embodiments shown, the closing card is not limited to these embodiments. It is to be understood that even though numerous characteristics and advantages of various embodiments of the present invention have been set forth in the foregoing description, together with details of the structure and function of various embodiments of the invention, these embodiments are illustrative only, and changes may be made in detail, especially in matters of structure and arrangement of parts within the principles of the present invention to the full extent indicated by the broad general meaning of the terms in which the appended claims are expressed. For example, the particular features or elements may vary depending on the particular closing card design chosen and whether its component parts are organized or designed differently while maintaining substantially the same functionality without departing from the scope and spirit of the present invention.

1. A closing card, comprising:
a card providing information, the card having a first side and a second side, wherein the closing card comprises at least one advertising block and one announcement block.

2. The closing card of claim 1, wherein the advertising block is placed on the first side or the second side of the card.

3. The closing card of claim 1, wherein the announcement block is placed on the first side or the second side of the card.

4. The closing card of claim 1, wherein the information displayed in the advertising block is selected from the group consisting of vendor advertising information, contact information, marketing information, photographs, business logos, visual representations, and combinations thereof.

5. The closing card of claim 1, wherein the information displayed in the announcement block is selected from the group consisting of a greeting, an invitation, a date of moving, an address, visual representations, photographs, and combinations thereof.

6. The closing card of claim 1, wherein the card comprises a fold, the fold creating additional surfaces on which to place announcements or advertising information.

7. The closing card of claim 1, the first side of the card formatted for mailing, wherein the first side comprises a space for a return address, a recipient's address, and postage.

8. The closing card of claim 1, wherein the card is perforated.

9. The closing card of claim 1, wherein the card comprises an adhesive portion.

10. A method for creating a closing card comprising:
providing a card that has a first side and a second side,
incorporating a marketing medium for a real estate company, an agent, or a closing company,
wherein the marketing medium comprises at least an advertising block and an announcement block.

11. The method of claim 10 further comprising placing the advertising block on the first side or the second side of the card.

12. The method of claim 10 further comprising placing the announcement block on the first side or the second side of the card.

13. The method of claim 10 further comprising placing information in the advertising block, the information selected from the group consisting of vendor advertising information, contact information, marketing information, photographs, business logos, visual representations, and combinations thereof.

14. The method of claim 10 further comprising placing information in the announcement block, the information selected from the group consisting of a greeting, an invitation, a date of moving, an address, visual representations, photographs, and combinations thereof.

15. The method of claim 10 further comprising imparting a fold in the card thus providing additional surfaces on which to place announcements or advertising.

16. The method of claim 10 further comprising formatting the first side of the card for mailing with space for a return address, a recipient's address, and postage.

17. The method of claim 10 further comprising creating a perforation on the card.

18. The method of claim 10 further comprising placing an adhesive on one side of the card.

19. A method for creating and ordering a closing card that incorporates a marketing medium for a real estate company, an agent, or a closing company, the method comprising uploading at least an advertising block and an announcement block and allowing uploading of a buyer's information, an announcement message, a name, an address, a house photograph, a buyer's photo or an invitation on a first side of the card over a computer network to a server.

20. The method of claim 19, further comprising allowing uploading a buyer's information, a logo, a sales mark, a name, a title, an address, a phone number, a fax number, an email, a website and/or photograph on a second side of the card over a computer network to a server.
